(19) United States
(12) Patent Application Publication
(10) Pub. No.: US 2017/0187204 A1
(43) Pub. Date: Jun. 29, 2017

(54) BATTERY MANAGEMENT SYSTEM FOR HUMAN-MACHINE INTERACTION VEHICLES

(71) Applicant: HANGZHOU CHIC INTELLIGENT TECHNOLOGY CO., LTD, Hangzhou (CN)

(72) Inventor: Jiawei Ying, Hangzhou (CN)

(73) Assignee: HANGZHOU CHIC INTELLIGENT TECHNOLOGY CO., LTD, Hangzhou (CN)

(21) Appl. No.: 15/176,722

(22) Filed: Jun. 8, 2016

(30) Foreign Application Priority Data
Dec. 24, 2015 (CN) 201510989143.4
Dec. 24, 2015 (CN) 201511035756.0
Mar. 21, 2016 (CN) 201610160755.7
Mar. 21, 2016 (CN) 201610162243.4

(51) Int. Cl. H02J 7/00; B60L 11/18

(52) U.S. Cl. CPC H02J 7/0024; H02J 7/0072; H02J 7/0021; B60L 11/1861; B60L 11/187

(57) ABSTRACT

A battery management system for human-machine interaction vehicles includes a main control board, a battery pack, and an information sampling module. The main control board may include a main control module, a first electronic switch, a second electronic switch, and a first charge-discharge module. The battery pack may include a cell. The main control module may determine whether the information of the cell from the information sampling module is abnormal. When the information of the cell is abnormal, the first electronic switch may be turned off during the cell being discharged, and the second electronic switch may be turned off during the cell being charged.

### CROSS-REFERENCE TO RELATED APPLICATIONS

This application claims priority to Chinese Patent Application Nos. 201610160755.7 filed on Mar. 21, 2016, 201610162243.4 filed on Mar. 21, 2016, 201511035756.0 filed Dec. 24, 2015 and 201510989143.4 filed Dec. 24, 2015, the contents of which are incorporated by reference herein in their entirety.

### FIELD OF THE DISCLOSURE

The subject matter herein generally relates to human-machine interaction vehicles, in particular to battery management systems for human-machine interaction vehicles.

### BACKGROUND OF THE DISCLOSURE

Human-machine interaction vehicles are also called body feeling vehicles or sensor-controlled vehicles. As the traffic congestion in cities is getting increasingly serious, human-machine interaction vehicles are becoming more and more popular. The human-machine interaction vehicles are generally used in short distance, such as within ten kilometers. To improve portability, the human-machine interaction vehicles generally have a small size.

To provide sufficient power, lithium-ion batteries are typically used to supply power for conventional human-machine interaction vehicles. However, the temperature of a lithium-ion battery may exceed the scope of the specification when the battery is being charged or discharged. It is thus necessary to provide a safe battery management system for human-machine interaction vehicles.

### SUMMARY OF THE DISCLOSURE

In view of the above, a purpose of the disclosure is to provide a safe battery management system for human-machine interaction vehicles.

A battery management system may include a main control board, a battery pack, and an information sampling module. The main control board may include a main control module, a first electronic switch, a second electronic switch, and a first charge-discharge module. The battery pack may include a cell. The information sampling module may sample information of the cell and transmit a information signal to the main control module. A control terminal of the first electronic switch may be connected to the main control module. An input terminal of the first electronic switch may be connected to the first charge-discharge module. An output terminal of the first electronic switch may be connected to loads. A control terminal of the second electronic switch may be connected to the main control module. An output terminal of the second electronic switch may be connected to the first charge-discharge module. An input terminal of the second electronic switch may be connected to an external energy source interface. The first charge-discharge module may be connected to the cell. The main control module may determine whether the cell information from the information sampling module is abnormal. When the cell information is abnormal, the first electronic switch may be turned off by the main control module during the cell being discharged, and the second electronic switch may be turned off by the main control module during the cell being charged.

In at least one embodiment, the battery cell may further include a second charge-discharge module, a management module, a discharge switch, and a charge switch. The second charge-discharge module may be connected to the first charge-discharge module. The cell may be connected to the second charge-discharge module through the discharge switch and the charge switch, respectively. Control terminals of the discharge switch and charge switch may be connected to the management module. The information sampling module may be connected to the management module. The management module may receive an information signal of the cell from the information sampling module and transmit the information signal to the main control module. The management may determine whether the cell is abnormal according to the information signal. When the cell is determined to be abnormal, the discharge switch may be turned off by the management module during the cell being discharged, and the charge switch may be turned off by the management module during the cell being charged.

In at least one embodiment, the information sampling module may include a temperature sampling unit configured to sample temperature of the cell and transmitting a temperature signal to the management module. The management module may determine whether the cell temperature is higher than a preset temperature. When the cell temperature is higher than the preset temperature, the first electronic switch may be turned off by the main control module and the discharge switch may be turned off by the management module during the cell being discharged, and the second electronic switch may be turned off by the main control module and the charge switch may be turned off by the management module during the cell being charged.

In at least one embodiment, the main control board may further include a first temperature sampling interface connected to the main control module. The battery pack may further include a second temperature sampling interface connected to the temperature sampling unit. The first temperature sampling interface may further be connected to the second temperature sampling interface. The temperature sampled by the temperature sampling unit may be transmitted to the main control module through the first and second temperature sampling interfaces.

In at least one embodiment, the information sampling module may further include a voltage sampling unit connected to the cell and the management module and configured to sample a voltage of the cell and transmit a voltage signal to the management module and the main control module. When the management module determines that the voltage of the cell is out of a predetermined range, the first electronic switch may be turned off by the main control module and the discharge switch may be turned off by the management module during the cell being discharged, and the second switch may be turned off by the main control module and the charge switch may be turned off by the management module during the cell being charged.

In at least one embodiment, the information sampling module may further include a current sampling unit connected to the cell and the management module and configured to sample a current of the cell and transmit a current signal to the management module and the main control module. When the management module determines that when the current of the cell is out of a predetermined range, the first electronic switch may be turned off by the main control module and the discharge switch may be turned off by the management module during the cell being discharged, and the second switch may be turned off by the main control module and the charge switch may be turned off by the management module during the cell being charged.

In at least one embodiment, the main control board may further include a first communication module connected to the main control module. The battery pack may further include a second communication module connected to the management module. The first communication module may be connected to the second communication module,

In at least one embodiment, the discharge switch may be a discharge metal-oxide-semiconductor field-effect transistor (MOSFET), and the charge switch may be a charge MOSFET.

In at least one embodiment, the main control board may further include a warning module connected to the main control module. When the main control module determines that the information signal of the cell is abnormal, the warning module may be controlled by the main control module to issue alarm signals.

In at least one embodiment, the main control board may further include a display module connected to the main control module and configured to display the cell information.

Compared with the prior art, the battery management system according to the disclosure uses an information sampling module to sample the cell information and transmits the sampled information to the main control module, which thus determines whether the cell information indicates that the cell is abnormal. Accordingly, when the cell information is abnormal, the first electronic switch or the second electronic switch may be turned off. Thus, the battery explosion due to excessive temperature can be effectively avoided.

### BRIEF DESCRIPTION OF THE DRAWINGS

FIG. 1 shows a block diagram illustrating a battery management system for a human-machine interaction vehicle according to an embodiment of the present disclosure.

FIG. 2 shows a block diagram illustrating an information sampling module of the battery management system shown in FIG. 1.

### DETAILED DESCRIPTION

The following embodiments are meant to merely illustrate, but not to limit, the present disclosure with reference to the accompanying drawings. Obviously, bearing the essence and concept of the disclosure, those of skill in the art can make various changes and modifications to the disclosure. It should be understood that these changes and modifications shall all be covered by the disclosure, if they are made without departing from the spirits and scope of the disclosure.

It should also be understood that terms such as “first”, “second”, etc. are used to merely denote but not to limit the devices. For instance, the description hereafter may use “first” to denote one device, and use “second” to denote the same device. Note that when the phrase “connected to” is used hereinafter, it can mean two devices either “being connected to each other” or “being connected to another device in between”. Otherwise, when the phrase “directly connected to” is used hereinafter, it can mean “being connected without any intermediate devices”.

The terms being used hereinafter are meant to describe the referenced embodiments but not to limit the disclosure. Unless otherwise stated in the contexts, the use of singular or plural forms shall not limit the disclosure.

It should further be understood that the use of “comprise”, “comprising”, “be comprised of”, or “include”, “including” shall not limit the disclosure to the described or listed features and characteristics of a circuit. There may exist other features and characteristics of the circuit which have not been covered or listed in the disclosure.

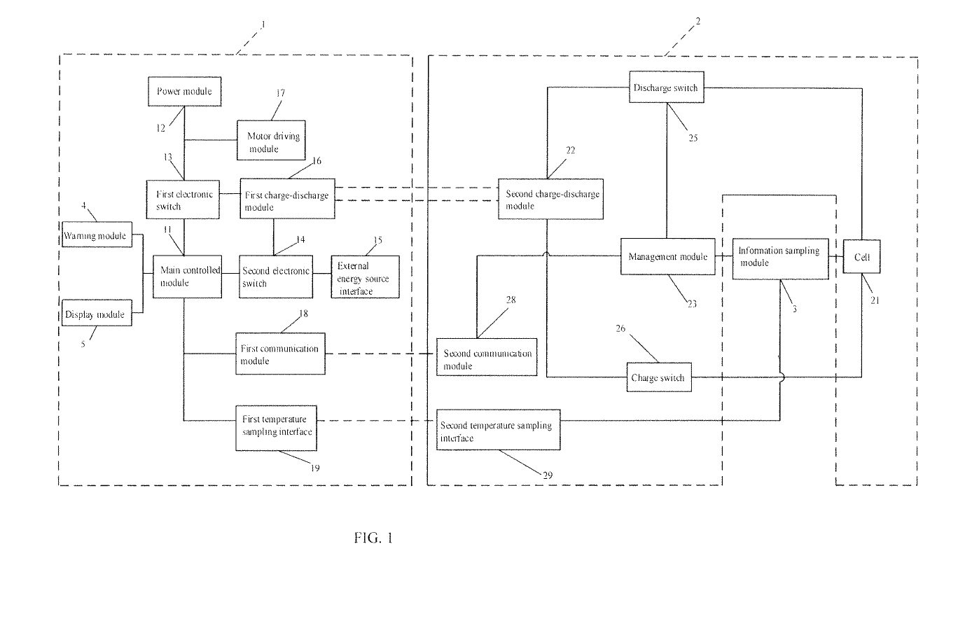

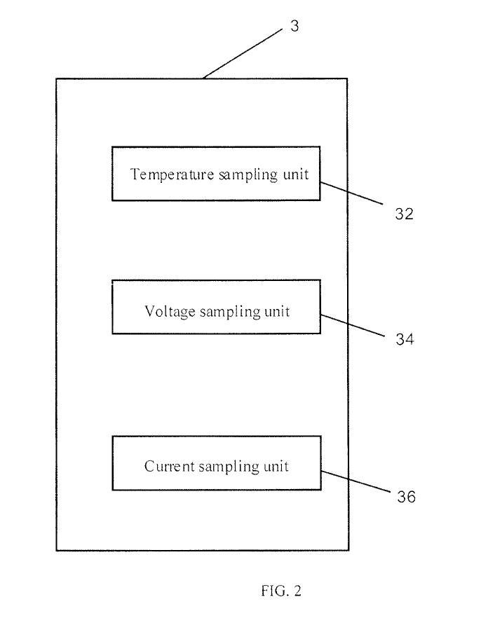

FIGS. 1 and 2 illustrate a battery management system for human-machine interaction vehicles according to a first embodiment. The battery management system includes a main control board 1, a battery pack 2, and an information sampling module 3.

The main control board 1 may include a main control module 11, a first electronic switch 13, a second electronic switch 14, an external energy source interface 15, and a first charge-discharge module 16. The battery pack 2 may include a cell 21, a second charge-discharge module 22, a management module 23, a discharge switch 25, and a charge switch 26.

A control terminal of the first electronic switch 13 may be connected to the main control module 11. An input terminal of the first electronic switch 13 may be connected to a discharge terminal of the first charge-discharge module 16. An output terminal of the first electronic switch 13 may be configured to connect to loads. In this embodiment, the main control module 11 may be a main control central processing unit (CPU) installed on the main control board 1 of the human-machine interaction vehicle. The loads may include a power module 12 mounted on the main control board 1 and a motor driving module 17. The first charge-discharge module 16 may be connected to the cell 21 through the second charge-discharge module 22. The main control module 11 may control the first electronic switch 13. When the first electronic switch 13 is turned on, the cell 21 may supply power to the power module 12 and the motor driving module 17, thereby supplying power for the human-machine interaction vehicle.

The cell 21 may be connected to a discharge terminal of the second charge-discharge module 22 through the discharge switch 25. A control terminal of the discharge switch 25 may be connected to the management module 23. The management module 23 may control the discharge switch 25. When the cell 21 supplies power to the power module 12 and the motor driving module 17, both the first electronic switch 13 and the discharge switch 25 may be turned on. In other embodiments, the discharge terminal of the second charge-discharge module 22 may be connected to the cell directly. In this manner, the main control module 11 may control the first electronic switch 13 to enable the cell 21 to supply power or otherwise. In addition, the first electronic switch 13 can be optional. The power module 12 and the motor driving module 17 may then be connected to a discharge terminal of the first charge-discharge module 16. The discharge terminal of the second charge-discharge module 22 may connected to the cell 21 through the discharge switch 25. In this manner, the management module 23 can control the discharge switch 25 to enable the cell 21 to supply power or otherwise.

A control terminal of the second electronic switch 14 may be connected to the main control module 11. An input terminal of the second electronic switch 14 may be connected to an external energy source interface 15. An output terminal of the second electronic switch 14 may be connected to a charge terminal of the first charge-discharge module 16. The main control module 11 may control the second electronic switch 14. When the external energy source interface 15 is connected to an external power supply and the second electronic switch 14 is simultaneously turned on, the external power supply can charge the cell 21. In this embodiment, a charge terminal of the second charge-discharge module 22 may be connected to the cell 21 through the charge switch 26. A control terminal of the charge switch 26 may be connected to the management module 23. The management module 23 may control the charge switch 26. When the second electronic switch 14 and the charge switch 26 are simultaneously turned on, the cell 21 can be charged. In other embodiments, the charge terminal of the second charge-discharge module 22 can be connected to the cell 21 directly. In this manner, the main control module 11 can control the second electronic switch 14 to enable the cell 21 to be charged or otherwise. In addition, the second electronic switch 14 can be optional. The external energy source interface 15 may then be connected to the charge terminal of the first charge-discharge module 16. The charge terminal of the second charge-discharge module 22 may be connected to the cell 21 through the charge switch 26. In this manner, the management module 23 can control the charge switch 26 to enable the cell 21 to be charged or otherwise.

The information sampling module 3 may be fitted into the battery pack 2, and connected to the main control module 11. The information sampling module 3 may sample the information of the cell 21 and transmit an information signal to the main control module 11. The main control module 11 may then determine whether the information sampled by the information sampling module 3 is abnormal. When the information of the cell 21 is determined to be abnormal, the first electronic switch 13 or the second electronic switch 14 may be turned off. More specifically, when the cell 21 is being discharged, the first electronic switch 13 may be turned off, when it is being charged, the second electronic switch 14 may be turned off.

Specifically, the information sampling module 3 may be connected to the management module 23 and configured to sample information of the cell 21 and transmit the cell information to the main control module 11 through the management module 23. The management module 23 may also determine whether the cell 21 is abnormal according to the cell information. If the cell 21 is abnormal, the discharge switch 25 may be turned off when the cell 21 is being discharged; and the charge switch 26 may be turned off when the cell 21 is being charged.

The information sampling module 3 may include a temperature sampling unit 32 connected to the management module 23. The temperature sampling unit 32 may sample the temperature of the cell 21 and transmit a temperature signal to the management module 23 and the main control module 11. The main control module 11 may determine whether the temperature of the cell 21 is higher than a preset temperature. When the temperature of the cell 21 is higher than the preset temperature, the first electronic switch 13 or the second electronic switch 14 may be turned off. Specifically, when the cell 21 is being discharged, the first electronic switch 13 may be turned off; when it is being charged, the second electronic switch 14 may be turned off.

The management module 23 may further determine whether the temperature of the cell 21 sampled by the temperature sampling unit 32 is higher than the preset temperature. When the temperature of the cell 21 is determined to be higher than the preset temperature, the discharge switch 25 or the charge switch 26 may be turned off. Specifically, when the cell 21 is being discharged, the discharge switch 25 may be turned off; when the cell 21 is being charged, the charge switch 26 may be turned off. The set temperature may be determined based on characteristics of the cell 21. The temperature sampling unit 32 may be a contact-type temperature sensor fitted onto a surface of the cell 21.

In this embodiment, the information sampling module 3 may further include a voltage sampling unit 34 connected to the cell 21 and the management module 23 and configured to sample a voltage of the cell 21 and transmit a voltage signal to the management module 23 and the main control module 11. When the cell 21 is being discharged, the voltage sampled by the voltage sampling unit 34 may be an output voltage of the cell 21. When the management module 23 determines that the output voltage of the cell 21 is out of a predetermined range, the first electronic switch 13 may be turned off. When the cell 21 is being charged, the voltage sampled by the voltage sampling unit 34 may be an input voltage of the cell 21. When the management module 23 determines that the input voltage of the cell 21 is out of a predetermined range, the second electronic switch 14 may be turned off.

The management module 23 may further determine whether the voltage sampled by the voltage sampling unit 34 is abnormal. Specifically, when the cell 21 is being discharged, the voltage sampled by the voltage sampling unit 34 may be the output voltage of the cell 21. When the management module 23 determines that the output voltage of the cell 21 is out of the predetermined range, the discharge switch 25 may be turned off. When the cell 21 is being charged, the voltage sampled by the voltage sampling unit 34 may be the input voltage of the cell 21. When the management module 23 determines that the input voltage of the cell 21 is out of the predetermined range, the charge switch 26 may be turned off.

In this embodiment, the information sampling module 3 may further include a current sampling unit 36 connected to the cell 21 and the management module 23 and configured to sample a current of the cell 21 and transmit a current signal to the main control module 11 and the management module 23. When the cell 21 is being discharged, the current sampled by the current sampling unit 36 may be an output current of the cell 21. When the management module 23 determines that the output current of the cell 21 is out of a predetermined range, the first electronic switch 13 may be turned off. When the cell 21 is being charged, the current sampled by the current sampling unit 242 may be an input current of the cell 21. When the management module 23 determines that the input current of the cell 21 is out of a predetermined range, the second electronic switch 14 may be turned off.

The management module 23 may further determine whether the current sampled by the current sampling unit 36 is abnormal. Specifically, when the cell 21 is being discharged, the current sampled by the current sampling unit 36 may be the output current of the cell 21. When the management module 23 determines that the output current of the cell 21 is out of the predetermined range, the discharge switch 25 may be turned off. When the cell 21 is being charged, the current sampled by the current sampling unit 36 may be the input current of the cell 21. When the management module 23 determines that the input current of the cell 21 is out of the predetermined range, the charge switch 26 may be turned off.

After an on-off switch of the human-machine interaction vehicle is turned on, the main control module 11 may turn on the first electronic switch 13, and the management module 23 may turn on the discharge switch 25. The cell 21 can thus supply power to the power module 12 and the motor driving module 17. As a result, the power module 12 can supply power to the human-machine interaction vehicle. Specifically, the power module 12 may convert a voltage outputted from the cell 21 to a 12-volt direct current (DC) voltage, 5-volt DC voltage, or 3.3-volt DC voltage, and thus supply power to the human-machine interaction vehicle.

When the cell 21 is being discharged, the temperature sampling unit 32 may sample the temperature of the cell 21 and transmit a temperature signal to the main control module 11 and the management module 23. When the main control module 11 determines that the temperature of the cell 21 is higher than the preset temperature, the main control module 11 may turn off the first electronic switch 13. When the management module 23 determines that the temperature of the cell 21 is higher than the preset temperature, the management module 23 may turn off the discharge switch 25. When the external energy source interface 15 is connected to an external power supply, the main control module 11 may turn on the second electronic switch 14, and the management module 23 may turn on the charge switch 26, so that the cell 21 can be charged.

During the cell 21 being charged, the temperature sampling unit 32 may sample the temperature of the cell 21 and transmit the temperature signal to the main control module 11 and the management module 23. When the main control module 11 determines that the temperature of the cell 21 is higher than the preset temperature, the main control module 11 may turn off the second electronic switch 14. When the management module 23 determines that the temperature of the cell 21 is higher than the set temperature, the management module 23 may turn off the charge switch 26.

In this embodiment, the main control board 1 may further include a first temperature sampling interface 19 connected to the main control module 11. The battery pack 2 may further include a second temperature sampling interface 29. The second temperature sampling interface 29 may be connected to the first temperature sampling interface 19, to transmit the temperature signal sampled by the temperature sampling unit 32 to the main control module 11. The main control module 11 may further determine whether the temperature transmitted through the first and second temperature sampling interfaces is higher than the preset temperature.

In other embodiments, the main control board 1 may further include a first communication module 18 connected to the main control board 1. The battery pack 2 may include a second communication module 28. The second communication module 28 may be connected to the management module 23. The second communication module 28 may further be connected to the first communication module 18, to transmit the information signal of the cell 21 to the main control module 11. The main control module 11 may further determine whether the information signal of the cell 21 is abnormal. When the main control module 11 determines that the information signal of the cell 21 is abnormal, the first electronic switch 13 may be turned off when the cell 21 is being discharged, and the second electronic switch 14 may be turned off when the cell 21 is being charged. Specifically, the information of the cell 21 may include the temperature of the cell 21, the current of the cell 21, or the voltage of the cell 21. When the main control module 11 determines that the temperature of the cell 21 is higher than the preset temperature, the first electronic switch 13 may be turned off when the cell 21 is being discharged, and the second electronic switch 14 may be turned off when the cell 21 is being charged. When the main control module 11 determines that the voltage of the cell 21 is out of the predetermined range, the first electronic switch 13 may be turned off when the cell 21 is being discharged, and the second electronic switch 14 may be turned off when the cell 21 is being charged. When the main control module 11 determines that the current of the cell 21 is out of the predetermined range, the first electronic switch 13 may be turned off when the cell 21 is being discharged, and the second electronic switch 14 may be turned off when the cell 21 is being charged.

In other embodiments, the battery pack 2 may include a plurality of cells 21. Correspondingly, the information sampling module 3 may include a plurality of temperature sampling units 32, a plurality of voltage sampling units 34, and a plurality of current sampling units 36. Each cell 21 may correspond to a temperature sampling unit 32, a voltage sampling unit 34, and a current sampling unit 36. Thus, the main control module 11 can receive a plurality of temperature signals from the temperature sampling units 32, a plurality of voltage signals from the voltage sampling units 34, and a plurality of current signals from the current sampling units 36. When the main control module 11 determines that one of the temperature, voltage, or current of the any one cell 21 is abnormal, the first electronic switch 13 would be turned off. When the management module 23 determines that one of the temperature, voltage, or current of the any one cell 21 is abnormal, the charge switch 26 would be turned off,

In this embodiment, the main control board 1 may further include a warning module 4 connected to the main control module 11. When the main control module 11 determines the information signal of the cell 21 is abnormal, the warning module 4 may be controlled by the main control module 11 to issue alarm signals to alert the user. The warning module 4 may be a buzzer. It should be noted that, when the information signal of the cell 21 is abnormal, it may indicate that the temperature of the cell 21 is higher than the preset temperature, the input/output voltage of the cell 21 is out of the predetermined range, or the input/output current of the cell 21 is out of the predetermined range.

In this embodiment, the main control board 1 may further include a display module 5. The display module 5 may be connected to the main control module 11 and configured to display the information of the cell 21. The information of the cell 21 may include the temperature of the cell 21, the input/output voltage of the cell 21, or the input/output current of the cell 21.

In this embodiment, the first and second electronic switches 13 and 14 may be transistors. The control terminal of the first or second electronic switch may correspond to a base of the transistor. The output terminal of the first or second electronic switch may correspond to an emitter of the transistor. The input terminal of the first or second electronic switch may correspond to a collector of the transistor. The discharge switch 25 may be a discharge MOSFET (Metal-Oxide-Semiconductor Field-Effect Transistor). The charge switch 26 may be a charge MOSFET.

In this embodiment, the main control board 1 may further include a sensor module and a motor driving module 17. The sensor module is connected to the main control module 11. The motor driving module 17 may be connected to a pulse-width modulation (PWM) driving interface of the main control module 11. The sensor module may include, but is not limited to, gyroscopes, acceleration sensors, and hall sensors. The gyroscope can measure an angle of avertence of the human-machine interaction vehicle, and transmit the angle of avertence to the main control module 11. The main control module 11 may control the motion of the human-machine interaction vehicle. The acceleration sensor can measure an acceleration of the human-machine interaction vehicle accordingly. The hall sensor can be mounted on the wheels of the human-machine interaction vehicle, to measure a speed of the human-machine interaction vehicle. The hall sensor may further transmit the speed information to the main control module 11. The main control module 11 may thus receive and process the angle of avertence, the acceleration, and the speed data, and generate motor driving signals accordingly. The main control module 11 may transmit the motor driving signals to the motor driving module 17. The motor driving module 17 may drive the motor accordingly.

The motor driving module 17 may be connected to the output terminal of the first electronic switch 13, so that when the cell 21 is being discharged, it can supply power to the motor.

To conclude, the battery management system can use the information sampling module 3 to sample the information of the cell 21, and transmit the sampled information to the main control module 11, which may then determine whether the information of the cell 21 is abnormal. When the information of the cell 21 is determined to be abnormal, the first or second electronic switch 14 may be turned off. Thereby, the battery explosion due to excessive temperature can be avoided.

The information of the cell 21 sampled by the information sampling module 3 may also be transmitted to the management module 23. The management module 23 may determine whether the information of the cell 21 is abnormal. When the information of the cell 21 is determined abnormal, the discharge switch 25 or the charge switch 26 may be turned off. Thus, the battery explosion due to excessive temperature can be avoided.

The battery management system can also use the temperature sampling unit 32 to sample the temperature of the cell 21, and transmit the sampled temperature to the management module 23. The management module 23 may determine whether the temperature of the cell 21 is higher than the preset temperature. When the temperature of the cell 21 is higher than the preset temperature, the discharge switch 25 or the charge switch 26 may be turned off. Thereby, the battery explosion due to excessive temperature can be avoided.

According to the above description, the battery management system provides two protection units to protect the cell 21. Thus, when any one does not work, the other one can still protect the cell 21 effectively. In addition, when any one protection unit loses its accuracy because of the surrounding environment, the other one can still precisely protect the cell 21.

Furthermore, the battery management system can further include the voltage sampling unit 34 to sample the voltage of the cell 21, and the current sampling unit 36 to sample the current of the cell 21. When either of the voltage or the current is out of the predetermined range, either the discharge switch 25 or the charge switch 26 can be turned off, so as to protect the cell 21.

Numerous details have been set forth in the above description. However, it should be appreciated that the disclosure can be implemented without these specific details. Note that the embodiments referenced above are merely some but not all embodiments of the disclosure, and those of skill in the art can make numerous substitutions and modifications to the disclosure without departing from the spirits and scope of the disclosure. Any of these substitutions and modifications shall all fall within the protection of the disclosure. And the appended claims shall prevail with regards to the scope of the disclosure.

1. A battery management system for human-machine interaction vehicles, comprising:
a main control board, comprising:
a main control module;
a first electronic switch;
a second electronic switch; and
a first charge-discharge module;
a battery pack, comprising:
a cell; and
an information sampling module configured to sample information of the cell and transmit an information signal to the main control module;
wherein a control terminal of the first electronic switch is connected to the main control module, an input terminal of the first electronic switch is connected to the first charge-discharge module; a control terminal of the second electronic switch is connected to the main control module, an output terminal of the second electronic switch is connected to the first charge-discharge module, and an input terminal of the second electronic switch is connected to an external energy source interface; and the first charge-discharge module is connected to the cell;
wherein the main control module determines whether the information of the cell transmitted from the information sampling module is abnormal according to the information signal; when the information of the cell is determined to be abnormal, the first electronic switch is turned off by the main control module during the cell being discharged, and the second electronic switch is turned off by the main control module during the cell being charged; and wherein
the battery pack further comprises a second charge-discharge module, a management module, a discharge switch, and a charge switch, wherein the second charge-discharge module is connected to the first charge-discharge module, the cell is connected to the second charge-discharge module through the discharge switch and the charge switch, respectively, control terminals of the discharge switch and the charge switch are respectively connected to the management module, and the information sampling module is connected to the management module, wherein the management module receives the information signal of the cell from the information sampling module and transmits the information signal to the main control module; the management module determines whether the cell is abnormal according to the information signal, when the cell is abnormal, the discharge switch is turned off by the management module during the cell being discharged, and the charge switch is turned off by the management module during the cell being charged.

2. The battery management system of claim 1, wherein the information sampling module comprises a temperature sampling unit configured to sample temperature of the cell and transmit a temperature signal to the management module; the management module determines whether the temperature of the cell is higher than a preset temperature, when the temperature of the cell is higher than the preset temperature, the first electronic switch is turned off by the main control module and the discharge switch is turned off by the management module during the cell being discharged, and the second electronic switch is turned off by the main control module and the charge switch is turned off by the management module during the cell being charged.

3. The battery management system of claim 2, wherein the main control board further comprises a first temperature sampling interface connected to the main control module, the battery pack further comprises a second temperature sampling interface connected to the temperature sampling unit, and the first temperature sampling interface is further connected to the second temperature sampling interface, wherein the temperature sampled by the temperature sampling unit is transmitted to the main control module through the first and second temperature sampling interfaces.

4. The battery management system of claim 1, wherein the information sampling module further comprises a voltage sampling unit connected to the cell and the management module and configured to sample a voltage of the cell and transmit a voltage signal to the management module and the main control module, wherein when the management module determines that the voltage of the cell is out of a predetermined range, the first electronic switch is turned off by the main control module and the discharge switch is turned off by the management module during the cell being discharged, and the second switch is turned off by the main control module and the charge switch is turned off by the management module during the cell being charged.

5. The battery management system of claim 1, wherein the information sampling module further comprises a current sampling unit connected to the cell and the management module and configured to sample a current of the cell and transmit a current signal to the management module and the main control module, wherein when the management module determines that the current of the cell is out of a predetermined range, the first electronic switch is turned off by the main control module and the discharge switch is turned off by the management module during the cell being discharged, and the second switch is turned off by the main control module and the charge switch is turned off by the management module during the cell being charged.

6. The battery management system of claim 1, wherein the main control board further comprises a first communication module connected to the main control module, the battery pack further comprises a second communication module connected to the management module, and the first communication module is connected to the second communication module.

7. The battery management system of claim 1, wherein the discharge switch is a discharge metal-oxide-semiconductor field-effect transistor (MOSFET), and the charge switch is a charge MOSFET.

8. The battery management system of claim 1, wherein the cell is connected to a charge terminal of the second charge-discharge module through the charge switch, and to a discharge terminal of the second charge-discharge module through the discharge switch.

9. The battery management system of claim 1, wherein the main control board further comprises a warning module connected to the main control module, when the main control module determines the information signal of the cell is abnormal, the warning module is controlled by the main control module to issue alarm signals.

10. The battery management system of claim 1, wherein the main control board further comprises a display module connected to the main control module and configured to display the information of the cell.

11. The battery management system of claim 1, wherein an output terminal of the first electronic switch is connected to loads.

12. The battery management system of claim 11, wherein the loads comprise a power module arranged on the main control board and a motor driving module.

13. The battery management system of claim 1, wherein the main control module is a main central processing unit (CPU) arranged on the main control board.

14. The battery management system of claim 1, wherein a discharge path comprises the first electronic switch, the first charge-discharge module, the second charge-discharge module, the discharge switch and the cell; a charge path comprises the second electronic switch, the first charge-discharge module, the second charge-discharge module, the charge switch and the cell; the first electronic switch is arranged on the discharge path and the second electronic switch is arranged on the charge path such that the first electronic switch and the second electronic switch are arranged on different paths respectively; and the discharge switch is arranged on the discharge path and the charge switch is arranged on the charge path such that the discharge switch and the charge path are arrange on different paths respectively.
